(19) United States
(12) Patent Application Publication
(10) Pub. No.: US 2010/0066780 A1
(43) Pub. Date: Mar. 18, 2010

(54) Liquid Ejecting Apparatus and Method of Forming Nozzle Test Pattern

(75) Inventor: Yasushi Akatsuka, Asahi-mura (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/560,381

(22) Filed: Sep. 15, 2009

(30) Foreign Application Priority Data
Sep. 16, 2008 (JP) 2008-237006

(51) Int. Cl. B41J 29/38

(52) U.S. Cl. 347/14

(57) ABSTRACT

A liquid ejecting apparatus includes a head that includes a plurality of nozzles disposed for each color of liquids and ejects liquids from the plurality of nozzles onto a medium; and a control unit that sets one of the plurality of nozzles as a test target nozzle and forms a nozzle test pattern used for testing defective liquid-ejection of the test target nozzle on a transparent color medium by landing the liquids ejected from the test target nozzle and a different nozzle of the plurality of nozzles, which is different from the test target nozzle, on the transparent color medium so as to be overlapped with each other.

### BACKGROUND

1. Technical Field

The present invention relates to a liquid ejecting apparatus and a method of forming a nozzle test pattern.

2. Related Art

Liquid ejecting apparatuses that have a head including a plurality of nozzles disposed for each color of liquids and ejects liquids from the nozzles onto a medium and a control unit that forms a nozzle test pattern used for testing the defective liquid-ejection of a test target nozzle with one of the plurality of nozzles set as the test target nozzle have been known. A user using such liquid ejecting apparatuses tests whether the test target nozzle is in the defective liquid-ejection state due to nozzle clogging or the like by visually recognizing the nozzle test pattern (for example, see JP-A-2007-168173).

However, there are cases where the nozzle test pattern is formed on a transparent color medium depending on situations. For example, in a printing apparatus that prints an image on a transparent color film sheet, usually, the film sheet is set as a printing medium. When a nozzle test pattern is formed in such a printing apparatus, it is inconvenient to replace the set film sheet with a different color medium (a white plain sheet or the like), and accordingly, the nozzle test pattern may be formed on the film sheet.

However, in a case where the nozzle test pattern is formed on a transparent color medium, when the type of the liquid cannot be easily identified in relation to the transparent color, it may be difficult to visually recognize the nozzle test pattern.

### SUMMARY

An advantage of some aspects of the invention is that it provides a liquid ejecting apparatus and a method of forming a nozzle test pattern which are capable of forming the nozzle test pattern, which is used for testing defective liquid-ejection of a test target nozzle, on a transparent color medium so as to be easily recognized visually by a user.

According to a major aspect of the invention, there is provided a liquid ejecting apparatus. The liquid ejecting apparatus includes: a head that includes a plurality of nozzles disposed for each color of liquids and ejects liquids from the plurality of nozzles onto a medium; and a control unit that sets one of the plurality of nozzles as a test target nozzle and forms a nozzle test pattern used for testing defective liquid-ejection of the test target nozzle on a transparent color medium by landing the liquids ejected from the test target nozzle and a different nozzle of the plurality of nozzles, which is different from the test target nozzle, on the transparent color medium so as to be overlapped with each other.

Another aspect of the invention will be apparent with reference to descriptions below and the accompanying drawings.

### BRIEF DESCRIPTION OF THE DRAWINGS

The invention will be described with reference to the accompanying drawings, wherein like numbers reference like elements.

FIG. 1 is a block diagram showing the entire configuration of a printer.

FIG. 2A shows a schematic internal configuration of the printer, and FIG. 2B is a cross-sectional view of the internal configuration of the printer.

FIG. 3 is a diagram showing the arrangement of nozzles.

FIG. 4 is a diagram showing the flow for generating print data.

FIG. 5 is a diagram showing a setting screen of a printer driver.

FIG. 6 is a diagram showing a utility screen.

FIG. 7A is a diagram showing a nozzle test pattern NP(K).

FIG. 7B is an enlarged diagram of one block BP(K).

FIGS. 8A and 8B are explanatory diagrams of a method of testing a nozzle by using a nozzle test pattern NP.

FIG. 9 is a diagram showing the flow of a nozzle test pattern forming process according to an embodiment of the invention.

FIG. 10 is a diagram showing nozzle test patterns NP that are formed in the nozzle test pattern forming process according to this embodiment.

FIG. 11 is a diagram for being compared to FIG. 10.

FIG. 12A is a diagram showing a mixed nozzle test pattern NP(CY).

FIG. 12B is a diagram for being compared to FIG. 12A.

### DESCRIPTION OF EXEMPLARY EMBODIMENTS

At least the followings become apparent with reference to descriptions below and the accompanying drawings.

According to a first aspect of the invention, there is provided a liquid ejecting apparatus. The liquid ejecting apparatus includes: a head that includes a plurality of nozzles disposed for each color of liquids and ejects liquids from the plurality of nozzles onto a medium; and a control unit that sets one of the plurality of nozzles as a test target nozzle and forms a nozzle test pattern used for testing defective liquid-ejection of the test target nozzle on a transparent color medium by landing the liquids ejected from the test target nozzle and a different nozzle of the plurality of nozzles, which is different from the test target nozzle, on the transparent color medium so as to be overlapped with each other. According to the above-described liquid ejecting apparatus, the nozzle test pattern, which is used for testing defective ink-ejection of the test target nozzle, can be formed on the transparent color medium so as to be easily recognized visually by a user.

In addition, in the above-described liquid ejecting apparatus, the control unit may be configured to form the nozzle test pattern, which is surrounded by a base and is formed with the liquid ejected from the test target nozzle, on the transparent color medium by landing the liquid ejected from the different nozzle on the transparent color medium, forming the base that is formed with the liquid ejected from the different nozzle, and then, landing the liquid ejected from the test target nozzle on the base. In such a case, by forming the nozzle test pattern on the base, the nozzle pattern can be more easily recognized visually by the user.

Furthermore, in the above-described liquid ejecting apparatus, it may be configured that the color of the liquid ejected from the test target nozzle is a chromatic color, and the color of the liquid ejected from the different nozzle is a white color. In such a case, the nozzle test pattern of the nozzle that ejects a liquid of a chromatic color can be formed so as to be more easily recognized visually by the user.

Moreover, in the above-described liquid ejecting apparatus, the control unit may be configured to form the nozzle test pattern having a color different from the color of the liquid ejected from the test target nozzle on the transparent color medium by landing the liquids ejected from the test target nozzle and the different nozzle on the transparent color medium in the overlapping manner so as to be mixed together. In such a case, the nozzle test pattern can be formed so as to be more easily recognized visually by the user by forming the nozzle test pattern in the color to be easily recognized.

Additionally, in the above-described liquid ejecting apparatus, the color of the liquid ejected from the test target nozzle and the color of the liquid ejected from the different nozzle may be configured to be different from each other. In such a case, the nozzle test pattern can be formed so as to be more easily recognized visually by the user by forming the nozzle test pattern in the color to be easily identified.

According to a second aspect of the invention, there is provided a method of forming a nozzle test pattern in which one of a plurality of nozzles disposed for each color of liquids is set as a test target nozzle, and the nozzle test pattern for testing defective liquid-ejection of the test target nozzle is formed on a transparent color medium. The method includes: landing a liquid ejected from a different nozzle of the plurality of nozzles, which is different from the test target nozzle, on the transparent color medium; and landing a liquid ejected from the test target nozzle on the transparent color medium so as to be overlapped with the liquid ejected from the different nozzle. According to the above-described method of forming the nozzle test pattern, the nozzle test pattern, which is used for testing defective ink-ejection of the test target nozzle, can be formed on the transparent color medium so as to be easily recognized visually by a user.

### Configuration of Liquid Ejecting Apparatus of this Embodiment

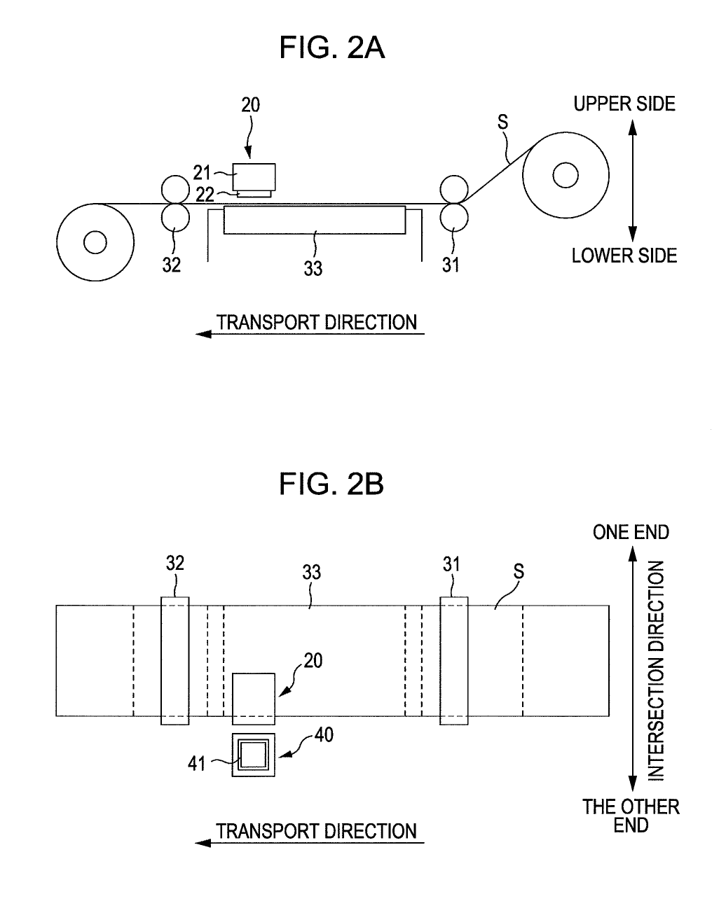

In this embodiment, as an example of a liquid ejecting apparatus, an ink jet printer (hereinafter, referred to as a printer 10) will be described. The printer 10 is an apparatus that forms (prints) an image on a medium S by ejecting ink as an example of a liquid on a medium S (see FIGS. 2A and 2B) that is continuous in a band shape. A portion (print material) of the medium S on which the image is printed is used after being cut out later. The medium S is set in the printer 10 in a state being wound in a roll shape and is continuously fed while the image is printed. The image that becomes the print material is printed in a direction in which the medium S is continued. As for the ink, either water-based ink or oil-based ink may be used.

In addition, the printer 10 of this embodiment is a printer for business as an example. The printer 10 performs printing by mainly using a colorless transparent film sheet as the medium S. In addition, in the printer 10 of this embodiment, ink of CMYK colors and white ink are ejected. This white ink is used for printing a white background image on the film sheet in a monochrome color for a case where an image is printed on the film sheet. In other words, by printing ink of CMYK colors on the background image formed with white ink in the overlapping manner, an image (main image) can be printed on the background image. When the white ink of this embodiment is overlapped with ink of a different color, the white ink is not mixed with the ink of the different color (the white ink and the ink of the different color do not spread into each other). In addition, since the white ink contains inorganic pigment, it has a light blocking property. Accordingly, an area of the film sheet in which the background image is formed with the white ink does not allow light to pass through it. As a result, the ink of the different color that is overlapped on the white ink can be easily recognized visually.

### Basic Configuration of Printer 10

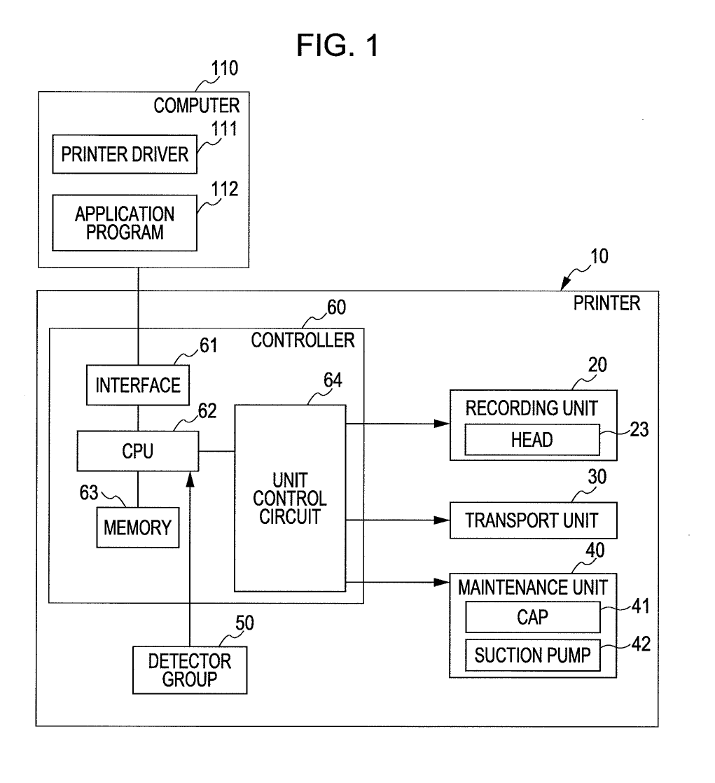

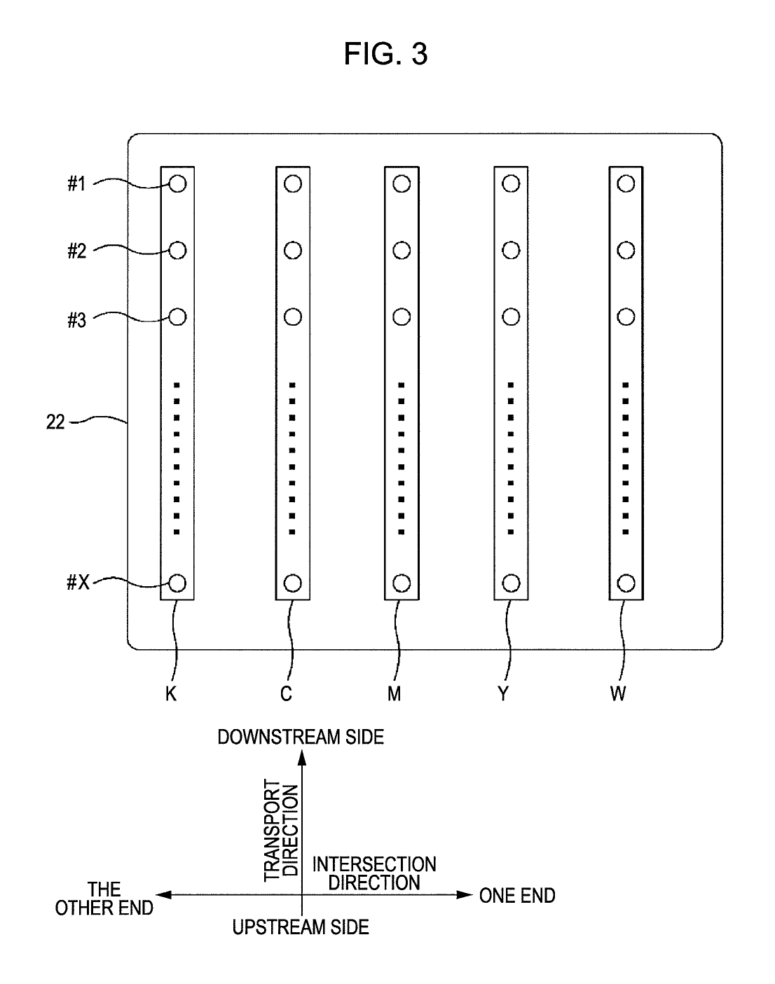

The basic configuration of a printer 10 will now be described with reference to FIGS. 1 to 3. FIG. 1 is a block diagram showing the entire configuration of the printer 10. FIG. 2A is a schematic diagram of the internal configuration of the printer 10, viewed from the side. In addition, FIG. 2B is a schematic diagram of the internal configuration of the printer 10, viewed from the upper side. FIG. 3 is a diagram showing the arrangement of nozzles.

The printer 10, as shown in FIG. 1, includes a recording unit 20, a transport unit 30, a maintenance unit 40, a detector group 50, a controller 60 as an example of a control unit, and the like.

The recording unit 20 records an image on a medium S. As shown in FIGS. 2A and 2B, the recording unit 20 includes a carriage 21 and a head 22. The carriage 21 is reciprocated by a driving mechanism not shown in the figure in the intersection direction that intersects a transport direction (described later).

The head 22 includes a bottom face (hereinafter, referred to as a nozzle face) in which the nozzles are arranged. The head 22 ejects ink onto the medium S from the nozzles in a state in which the nozzle face is opposite to the medium S. In addition, the head 22 is mounted on the carriage 21. Accordingly, the head 22 moves in a same direction (that is, the intersection direction) as the moving direction of the carriage 21 in accompaniment with the movement of the carriage 21. The head 22 moves in the moving direction so as to bring the nozzle face to face the medium S.

In the nozzle face, as shown in FIG. 3, a plurality of nozzles (in this embodiment, nozzles of five colors) that is arranged for each color of ink is included. Each of the plurality of nozzles is formed by a plurality of (in this embodiment, x) nozzle holes. The plurality of nozzle holes forms a row so as to be aligned with a constant nozzle pitch in the transport direction. In addition, a smaller number is assigned to a nozzle hole as the nozzle hole is located toward the downstream side (#1 to #x). For example, the nozzle hole #1 is located on the downstream side in the transport direction relative to the nozzle hole #x. In addition, nozzle holes to which a same number is assigned are located in an approximately same position in the transport direction.

In addition, in each nozzle hole, an ink chamber and a piezo element that are not shown in the figure are disposed. As the ink chamber is expanded or contracted by driving the piezo element, droplet-shaped ink is ejected from each nozzle hole. As the ejected droplet-shaped ink lands on the medium S, a dot is formed.

The transport unit 30 transports the medium S in the transport direction. Here, the transport direction is a direction in which the medium S is continued. The transport unit 30, as shown in FIG. 2A, includes a feed roller 31, a transport roller 32, and an adsorption table 33. The roll-shaped medium S set in the printer 10 is fed by the feed roller 31 and is transported towards a printable area. In the printable area, the medium S is sucked by the adsorption table 33 so as to be fixed on the adsorption table 33. Then, the medium S is transported to the downstream side in the transport direction by the transport roller 32. Accordingly, the medium S on which an image is printed is transported from the printable area to the downstream side in the transport direction. Finally, the medium S (in particular, a downstream-side end portion of the medium S on which the image has been printed) passes through a discharge port (not shown) so as to be discharged outside the printer 10.

The maintenance unit 40 is used for performing various maintenance operations so as to maintain excellent ink ejection from the nozzles. The maintenance unit 40, as shown in FIG. 2B, is located right below the head 22 when the head 22 is located in a position in which the nozzle face is located in a position (non-printing position, a standby position of the head 22), in which the nozzle face does not face the medium S, in the moving direction of the head 22. In addition, the maintenance unit 40, as shown in FIG. 1, includes a cap 41 and a suction pump 42. The cap 41 is brought into contact with the nozzle face of the head 22 so as to seal the nozzle (in particular, each nozzle hole). The suction pump 42 is operated in a state in which the cap 41 seals the nozzle. Accordingly, a negative-pressure state is formed inside the cap 41, and ink inside the nozzle is sucked and discharged forcedly.

As described above, the maintenance unit 40 performs an operation (cleaning operation) for forcedly discharging the ink inside the nozzles by using the suction pump 42 in a state in which the nozzles are sealed by the cap 41. By performing such a cleaning operation, the nozzle that is in the defective ink-ejection state due to clogging or the like is cleaned (in other words, the defective ink-ejection is eliminated). In addition, the above-described cleaning operation includes an operation for forcedly ejecting ink (so-called flushing) from each nozzle hole by driving the piezo element of each nozzle hole in a state in which the nozzles are sealed by the cap 41 is included, in addition to an operation for forcedly discharging the ink inside the nozzles by driving the suction pump 42 in a state in which the nozzles are sealed by the cap 41.

The controller 60 controls each unit (that is, the recording unit 20, the transport unit 30, and the maintenance unit 40) of the printer 10 through a unit control circuit 64 by using a CPU 62 in accordance with a program that is stored in a memory 63. The controller 60 can communicate with a computer 110 through an interface 61. When receiving print data from the computer 110, the controller 60 prints an image corresponding to the print data on a medium S by controlling each unit based on the print data. In addition, the state of the inside of the printer 10 is monitored by the detector group 50, and the detector group 50 outputs a signal corresponding to the detection result toward the controller 60.

### Printing Process

Next, a printing process that is performed by the printer 10 will be described. The printing process is started as the controller 60 receives print data including a print command from the computer 110 through the interface 61. Then, the controller 60 analyzes the contents of various commands included in the received print data and controls each unit of the printer 10. Next, the controller 60 performs a supply operation for feeding the roll-shaped medium S by using the feed roller 31 and supplying the medium S to the printable area.

Next, the controller 60 performs a dot forming operation in which dots are formed on the medium S by intermittently ejecting ink from the nozzles. A dot is formed by landing an ink droplet in a rectangular area (hereinafter, referred to as a unit area) that is virtually defined on the medium S. The size and the form of the unit area are determined based on the printing resolution. When the ink droplet is ejected ideally, the ink droplet land in a center position of the unit area. Thereafter, the ink droplet spreads, whereby a dot is formed in the unit area. In addition, the controller 60 moves the head 22 in the intersection direction when the dot forming operation is performed. As a result, a dot row (raster line) is formed on the medium S along the intersection direction.

Next, the controller 60 performs a transport operation in which the medium S is moved in the transport direction relative to the head 22 by the transport roller 32. By performing the transport operation, a raster line can be formed by the next dot forming operation in a position different from the position of the raster line that is formed by the previous dot forming operation. The controller 60 repeats the dot forming operation and the transport operation, and whereby a plurality of the raster lines is formed along the transport direction.

Then, the controller 60 repeats the dot forming operation and the transport operation until there is no print data to be printed on the medium S. At the time point when there is no print data, an image corresponding to the print data is printed on the medium S.

### Computer 110

Next, the computer 110 that is connected to the printer 10 will be described. The computer 110 outputs execution commands for various operations (for example, the cleaning operation), which are performed inside the printer 10, other than the print data toward the printer 10. In this computer 110, as shown in FIG. 1, programs such as a printer driver 111, an application program 112, and the like are installed.

The printer driver 111 receives image data from the application program 112, converts this image data into print data, and outputs the print data toward the printer 10. The print data includes data (hereinafter, referred to as pixel data) relating to pixels that constitute an image (print image) to be printed. The pixel data, for example, is data (data such as the color, the size, or the like of the dot) relating to dots that are formed in the unit area corresponding to a specific pixel.

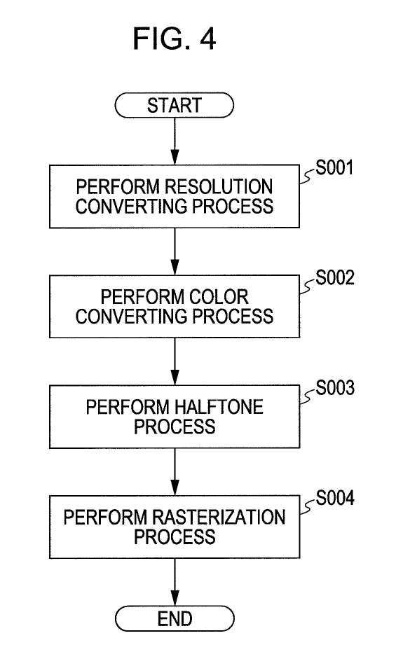

The print data, as shown in FIG. 4, is generated by sequentially performing a resolution converting process (S001), a color converting process (S002), a halftone process (S003), and a rasterization process (S004) by using the printer driver 111. FIG. 4 is a diagram showing the flow for generating the print data.

The resolution converting process is a process for converting the resolution of the RGB image data that is output from the application program 112 into the print resolution corresponding to a designated image quality. The color converting process is a process for converting the RGB image data, of which the resolution has been converted, into image data of four colors of CMYK. The plurality of pixel data that constitutes the image data is represented by a gray scale value having one of 256 levels.

The halftone process is a process for converting a multi-level gray scale value of the pixel data into a dot gray scale value having fewer levels that can be represented by the printer 10. In other words, in the halftone process, a gray scale value of 256 levels that is represented by the pixel data is converted into a dot gray scale value of 4 levels. In particular, the gray scale value is converted into one of four levels that includes no-dot formation corresponding to a dot gray scale value [00], small dot formation corresponding to a dot gray scale value [01], a medium dot formation corresponding to a dot gray scale value [10], and a large dot formation corresponding to a dot gray scale value [11]. Thereafter, after a dot generating rate is determined for the size of each dot, the pixel data is generated by using a dither method, a γ correction method, an error diffusion method, or the like, so that the printer 10 forms the dots in a diffused pattern.

The rasterization process is a process relating to the image data that is acquired by performing the halftone process. The rasterization process is a process for changing the data of dots (data of dot gray scale values) in the order of data to be transmitted to the printer 10. Then, the rasterized data is transmitted as a part of the print data.

In addition, when a main image is formed on a background image after forming the background image, the printer driver 111 generates print data of the main image and print data of the background image in the above-described sequence and transmits the print data toward the printer 10.

### Setting by Using Printer Driver 111

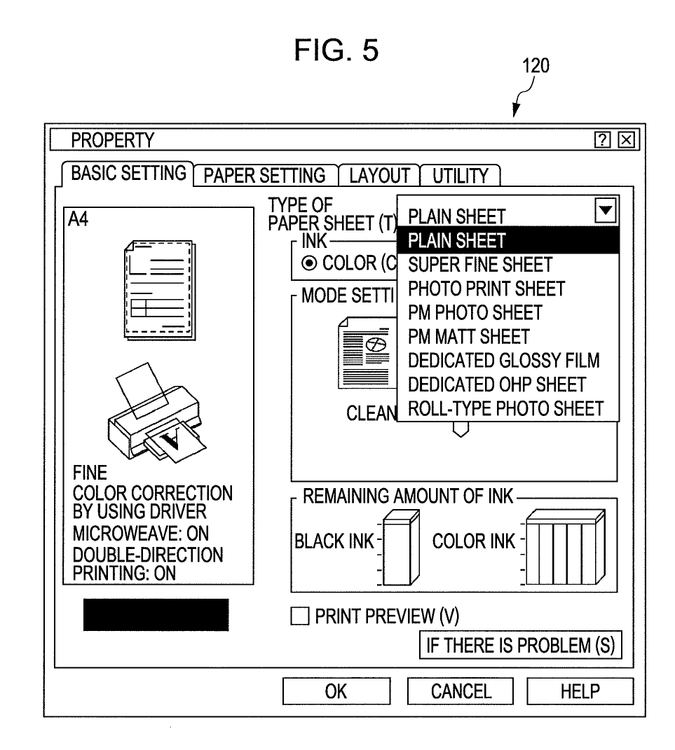

The printer driver 111, in order to accept a user's setting operation for the printing condition, displays a setting screen 120 shown in FIG. 5 in a display (not shown) of the computer 110. FIG. 5 is a diagram showing the setting screen 120. The user can select various printing conditions (the printing resolution or the type, the size, and the like of the medium S) through the setting screen 120. Then, the printer driver 111 generates the print data in accordance with the selected printing conditions.

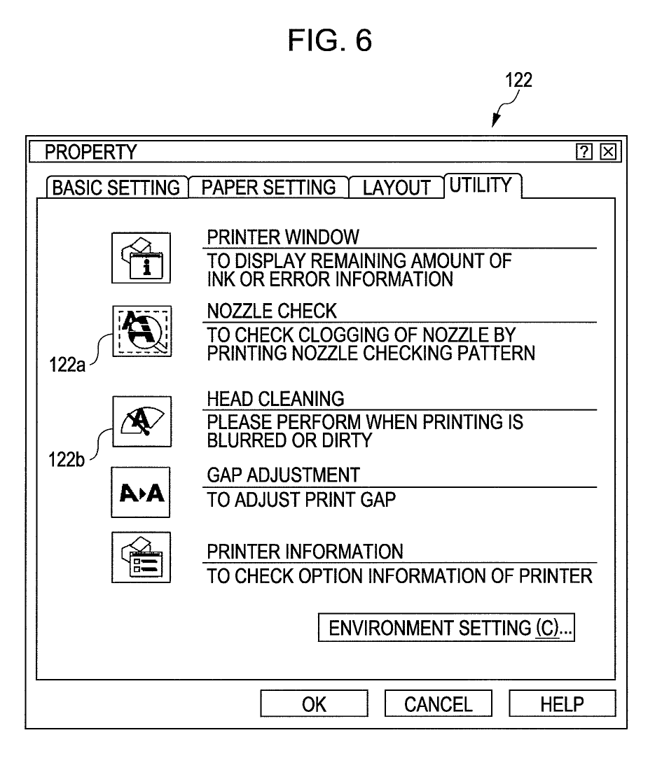

The setting screen 120 can be switched over in accordance with the type of the setting content. The setting screen 120 shown in FIG. 5 can be switched to a basic setting screen, a paper setting screen, a layout setting screen, or a utility setting screen. The user can allow the printer 10 to print a nozzle test pattern NP to be described later through the utility setting screen (hereinafter, referred to as a utility screen 122) of the setting screen 120 (see FIG. 6). Furthermore, the user can perform the cleaning operation by using the maintenance unit 40 through the utility screen 122 (in particular, by clicking on the cleaning button 122b shown in FIG. 6).

### Nozzle Test Pattern

In printing an image on a medium S by using the printer 10, there are cases where ink is not ejected from a nozzle and a dot is not appropriately formed in a unit area in which a dot is to be formed originally. Such a case is referred to as a nozzle missing phenomenon and is one factor for decreasing the quality of a printed image. The occurrence of the nozzle missing phenomenon means that the nozzle is in a defective ink-ejection state that is caused by nozzle clogging or the like.

In order to avoid deterioration of the image quality due to the above-described nozzle missing phenomenon, a user tests whether each nozzle can eject ink without any problem on a regular basis. When the defective ink-ejection of a test target nozzle is tested, a process for forming a nozzle test pattern NP on the medium S by landing the ink ejected from the test target nozzle on the medium S is performed. The user tests whether the test target nozzle is in the defective ink-ejection sate by visually recognizing the nozzle test pattern NP or the like. In other words, the nozzle test pattern NP is a pattern for testing the defective ink-ejection (defective liquid-ejection) of the test target nozzle.

For example, after the image is printed on the medium S after the above-described cleaning operation is performed, the process (hereinafter, also referred to as a nozzle test pattern forming process) for forming the nozzle test pattern NP is performed. In other words, when an image is printed, the nozzle test pattern NP is formed for checking that the nozzle has been in the state in which ink can be ejected appropriately. In other words, the nozzle test pattern NP is formed additionally when an image to be printed is printed on the medium S. In addition, the nozzle test pattern NP is formed so as to assure that the nozzle has been in the normal state at the time of printing the image.

Hereinafter, a reference example of a method of forming the nozzle test pattern NP by using the printer 10 (hereinafter, may be simply referred to as a reference example) will be described. In addition, the problem in the reference example will be described.

### Reference Example

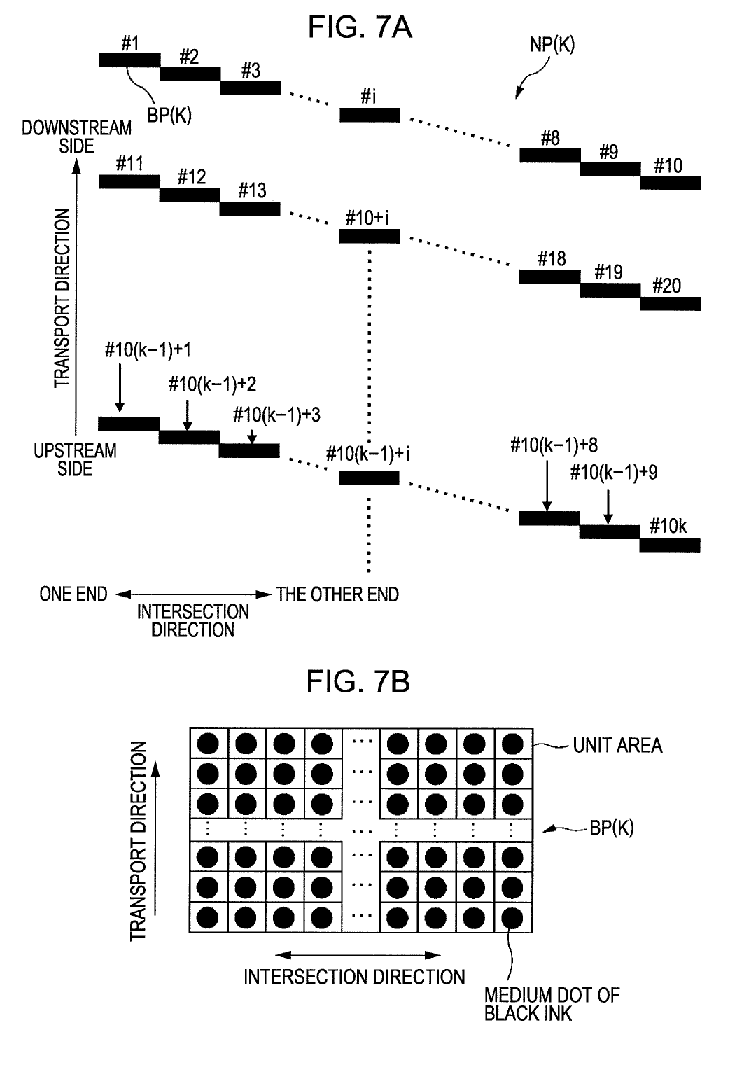

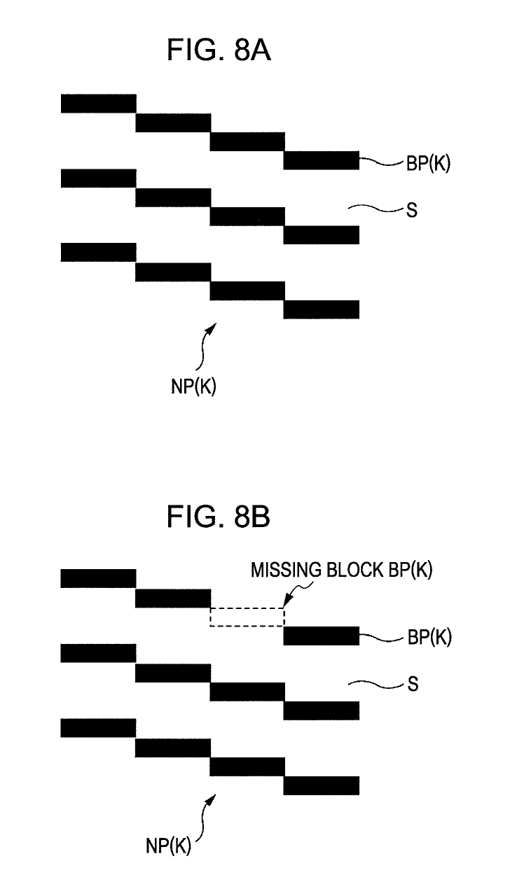

The reference example will be described with reference to FIGS. 6, 7A, 7B, 8A, and 8B. FIG. 6 is a diagram showing the above-described utility screen 122. FIG. 7A is a diagram showing the nozzle test pattern NP(K) that is used for testing the defective ink-ejection of a black ink nozzle. FIG. 7B is an enlarged diagram of one block BP(K) that constitutes the nozzle test pattern NP(K). FIGS. 8A and 8B are explanatory diagrams of a method of testing a nozzle by using the nozzle test pattern NP. FIG. 8A is a diagram for a case where the nozzle test pattern NP is appropriately formed, and FIG. 8B is a diagram for a case where a part of the nozzle test pattern NP is missing.

The controller 60 of the printer 10 sets one of the plurality of nozzles included in the head 22 as the test target nozzle and forms the nozzle test pattern NP of the test target nozzle on the medium S by landing the ink ejected from the test target nozzle on the medium S. In addition, the controller 60 sets each nozzle of the plurality of nozzles as the test target nozzle and forms the nozzle test pattern NP of each nozzle. In the reference example, the test nozzle pattern NP of each nozzle is printed in a monochrome color with ink ejected from each nozzle. For example, the test pattern NP of the black ink nozzle is printed only with black ink.

Hereinafter, the sequence of forming the nozzle test pattern NP according to the reference example will be described. In addition, the sequence of forming the nozzle test pattern NP is the same for each nozzle. Thus, hereinafter, a case where the nozzle test pattern NP(K) is formed by using the black ink nozzle as the test target nozzle will be described as an example.

In order to form the nozzle test pattern NP, a user clicks on a nozzle testing button 122a (see FIG. 6) that is displayed on the utility screen 122. By this clicking operation, the printer driver 111 accepts a user's request, generates print data for forming the nozzle test pattern NP of each of the plurality of nozzles, and outputs the print data toward the printer 10.

When receiving the above-described print data, the controller 60 repeats the dot forming operation and the transport operation, described above, based on the print data of the nozzle test pattern NP(K) of the black ink nozzle that is included in the above-described print data. In other words, the controller 60 forms the nozzle test pattern NP(K) of the black ink nozzle by landing the black ink ejected from the black ink nozzle on the medium S. Since the nozzle test pattern NP(K) of the black ink nozzle is formed with black ink, and the color of the nozzle test pattern is black.

In addition, the nozzle test pattern NP(K) of the black ink nozzle, as shown in FIG. 7A, is formed by blocks BP(K), the number of which is the same as the number (in this embodiment, x) of nozzle holes configuring the black ink nozzle. Described in more detail, as shown in FIG. 7A, rectangular blocks BP(K) are aligned in the shape of a stair in the direction corresponding to the moving direction of the head 22, and also, the rectangular blocks are aligned at constant intervals along the direction corresponding to the transport direction.

Each block BP(K), as shown in FIG. 7A, is surrounded by a background color portion of the medium S. In other words, in the reference example, the nozzle test pattern NP(K) that is surrounded by the background color portion of the medium S is formed. Here, the background color portion is a portion of the medium S that is constituted by unit areas in which the controller 60 does not allow the ink to land.

In addition, each block BP(K) corresponds to one of the plurality of nozzle holes that constitutes the black ink nozzle and is formed by black ink that is ejected from the corresponding nozzle hole. When the correspondence relationship between the block BP(K) and the black ink nozzle hole is described, the block BP(K) that is located on the lowermost stream side in the transport direction and is located in one end side in the moving direction of the head 22 corresponds to the nozzle hole #1. In addition, as shown in FIG. 7A, the block BP(K) that is located in the i-th position viewed from the block BP(K) that is located on one end side in the moving direction of the head 22 and is located in the k-th position viewed from the block BP(K) that is located on the lowermost stream side in the transport direction corresponds to the nozzle hole #10(k−1)+i.

In addition, focusing on one of the plurality of blocks BP(K), as shown in FIG. 7B, the block BP(K) is formed by a plurality of dots including p dots aligned along the direction corresponding to the moving direction of the head 22 and q dots aligned along the direction corresponding to the transport direction. In addition, in the reference example, the dots constituting the block BP(K) are formed as medium dots. In other words, when the print data of the nozzle test pattern NP(K) is generated, the printer driver 111 sets the dot gray scale value of each pixel data configuring the image data of the nozzle test pattern NP(K) to [10].

In addition, in one dot forming operation (an operation of moving the head 22 in the movement range from one end to the other end), one dot group of q dot groups (each dot group is formed by p dots aligned in the moving direction of the head 22) aligned in the transport direction is formed. Accordingly, in order to form q dot groups in the transport direction (in other words, in order to form the block BP(K)), the dot forming operation and the transport operation are alternately repeated q times so as to form the block BP(K). At that moment, when the block BP(K) is formed such that one dot is large and whether the dot is formed can be easily checked, q may be one. In such a case, the block BP(K) is formed by performing the dot forming operation once.

After the nozzle test pattern NP(K) as described above is formed on the medium S, the user tests defective ink-ejection of the black ink nozzle (that is, the test target nozzle) by visually recognizing the nozzle test pattern NP(K). In addition, as described above, the nozzle test pattern NP(K) is surrounded by the background color portion of the medium S. Accordingly, when visually recognizing the nozzle test pattern NP(K), the user compares the color (that is, black) of ink that configures the nozzle test pattern NP(K) with the color of the background color portion (that is, the color of the medium S).

Now, a method of testing the black ink nozzle will be described in detail. As shown in FIG. 8A, when a nozzle test pattern NP(K) that is formed by blocks BP(K), the number of which is the same as the number of nozzle holes of the black ink nozzle, is formed, it is determined that the black ink nozzle is normal. On the other hand, as shown in FIG. 8B, when a part of the nozzle test pattern NP(K) is missing, it is determined that the black ink nozzle is in the defective ink-ejection state. In other words, when a block BP(K) is not actually formed in a portion in which the block BP(K) of the nozzle test pattern NP(K) is originally to be formed on the medium S, and the color of the portion is the background color of the medium S, it is determined that nozzle missing occurs in a nozzle hole corresponding to the block BP(K) that is not formed.

### Problem in Reference Example

In the above-described sequence, each nozzle test pattern NP is formed (printed) on the medium S with each of the plurality of nozzles (nozzles of five colors) used as the test target nozzle. Then, in the reference example, as described above, the nozzle test pattern NP of the test target nozzle is formed only with ink ejected from the test target nozzle (in other words, printed in a monochrome color).

On the other hand, there are cases where the color of the medium S on which the nozzle test pattern NP is formed is a transparent color. Described in detail, in a printer 10 that prints an image on a film sheet by setting a colorless transparent roll-shaped film sheet, usually, the film sheet is set. When the nozzle test pattern NP is formed in such a printer 10, it is inconvenient to replace the film sheet that has been set with a medium of a different color (for example, a roll sheet of a white color). In particular, as the scale of the printer 10 becomes larger as that of a printer for business (in other words, as the size of the film to be set becomes larger), it becomes more inconvenient and time-consuming to replace the film sheet that has been set with a medium of a different color. Accordingly, in the above-described type of the printer 10, there are cases where the nozzle test pattern NP is formed on the colorless transparent film sheet.

In addition, as described above, when the nozzle test pattern NP is formed additionally to the process of printing a target print material for assuring the printing quality of the target print material, it is preferable that both the target print material and the nozzle test pattern NP are formed on a same medium S even after completion of the printing process by forming the nozzle test pattern NP on a medium S on which the target print material is printed. For the reasons as described above, the nozzle test pattern NP is formed on a colorless transparent film sheet.

However, when only the ink that is ejected from a target test nozzle lands on the transparent color medium S (in other words, when the nozzle test pattern NP is printed in a monochrome color) at the time of forming the nozzle test pattern NP of the test target nozzle on the transparent color medium S, there are cases where the nozzle test pattern NP formed in the color of the ink ejected from the test target nozzle cannot be easily recognized visually.

In other words, there is a nozzle among the plurality of nozzles that ejects ink of a color that cannot be easily identified in relation to the transparent color. For example, when ink of a chromatic color (in particular, yellow ink) is directly landed on the transparent color film sheet, it is difficult to identify the ink. The reason is that the film sheet is formed of a material through which light can be transmitted, and accordingly, when the ink of the chromatic color is landed on the film sheet, the ink of the chromatic color cannot be easily seen through. Described in detail, in order to allow the ink of the chromatic color, which is landed on the film sheet, to be visually recognized, an effort of holding up the film sheet to the light or the like is needed.

In addition, when the nozzle test pattern NP is not easily recognized visually by the user, it is difficult to appropriately test whether the nozzle (test target nozzle) tested by using the nozzle test pattern NP is in the defective ink-ejection state. In other words, even when the nozzle test pattern NP is formed normally, there is a possibility that the user determines that the nozzle test pattern NP has not been formed (in other words, although a nozzle is in the normal state, the nozzle may be determined to be in the defective ink-ejection state). On the contrary, even when a part of the nozzle test pattern NP is not actually formed due to defective ink-ejection, there is a possibility that the user neglects the nozzle in the defective ink-ejection state without noticing the partial missing of the nozzle test pattern NP.

As described above, in the reference example, there is a problem that the nozzle test pattern NP, which is formed with ink that cannot be easily identified from the transparent color, cannot be easily recognized visually by the user. On the contrary, according to the printer 10 of this embodiment, even when the color of the medium S on which the nozzle test pattern NP is formed is a transparent color, the nozzle test pattern NP can be formed to be easily recognized visually by the user. Hereinafter, a method of forming the nozzle test pattern according to this embodiment will be described.

### Method of Forming Nozzle Test Pattern of this Embodiment

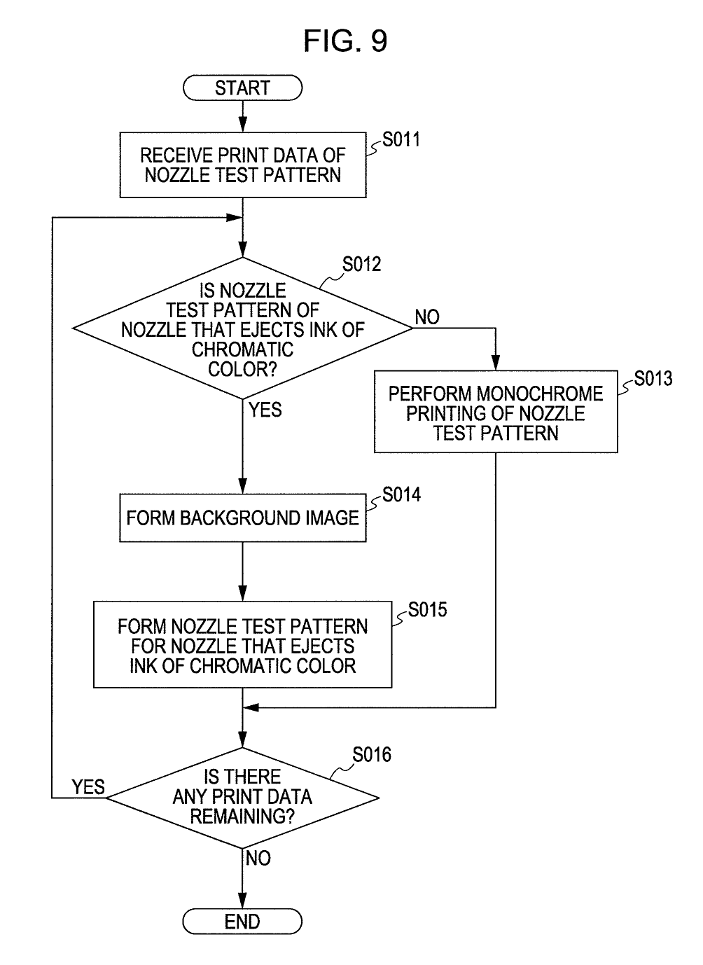

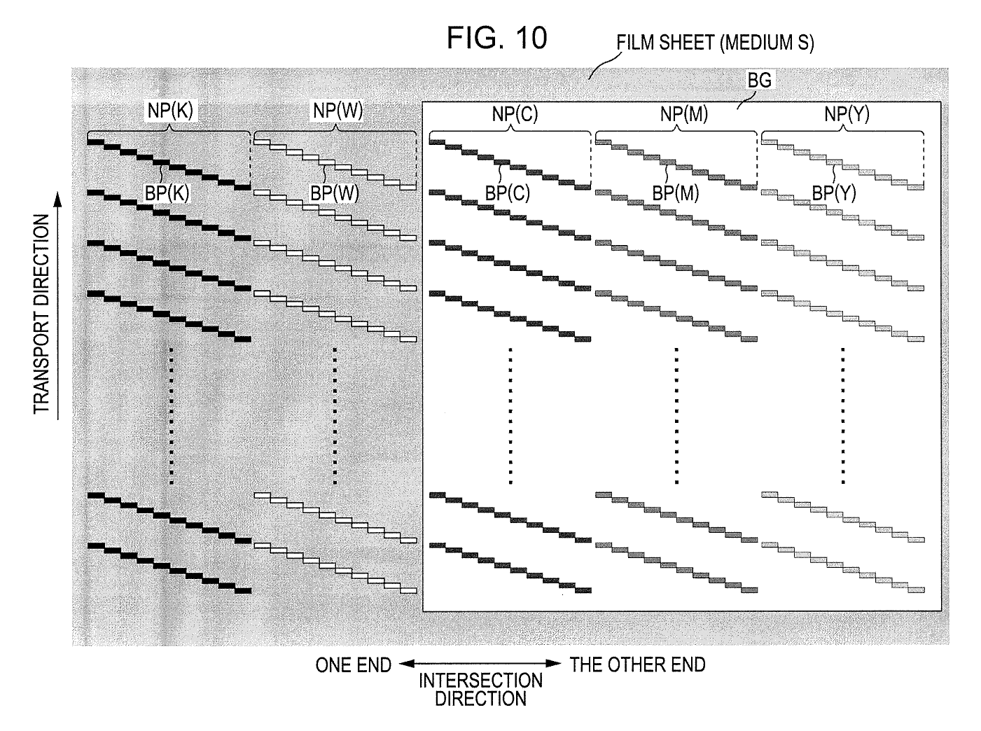

The method of forming a nozzle test pattern according to this embodiment will be described with reference to FIGS. 9 and 10. FIG. 9 is a diagram showing the flow of a nozzle test pattern forming process according to this embodiment. FIG. 10 is a diagram showing nozzle test patterns NP that are formed in the nozzle test pattern forming process according to this embodiment. In addition, in the description below, a case where a film sheet of which the background color is a transparent color (in particular, colorless transparent) is used as the medium S, and nozzle test patterns NP are formed on the film sheet will be described.

According to this embodiment, the process for forming the nozzle test pattern NP (nozzle test pattern forming process), as shown in FIG. 9, is started as the controller 60 of the printer 10 receives the print data of the nozzle test pattern NP from the printer driver 111 (S011). The print data, similarly to the reference example, is generated by the printer driver 111 with user's clicking on the nozzle testing button 1 22a used as a trigger.

Next, the controller 60 of the printer 10 repeats the dot forming operation and the transport operation based on the received print data, and whereby forming the nozzle test pattern NP of the test target nozzle on the film sheet. The controller 60 sets each of the plurality of nozzles as the test target nozzle and forms the nozzle test pattern NP of each test target nozzle.

Here, when forming the nozzle test pattern NP(K) and NP(W) of each of the black ink nozzle and the white ink nozzle (S012: NO), the controller 60 prints the nozzle test pattern NP(K) and NP(W) in a monochrome color (S013). In other words, when each of the black ink nozzle and the white ink nozzle is set as the test target nozzles, the controller 60 forms the nozzle test pattern NP(K) and NP(W) that is formed only with the ink ejected from the test target nozzle on the film sheet by directly landing the ink ejected from the test target nozzle on the film sheet.

On the other hand, when each of the nozzle test pattern NP(C), NP(M), and NP(Y) is formed by setting the nozzle from which ink of a chromatic color is ejected (that is, the cyan ink nozzle, the magenta ink nozzle, and the yellow ink nozzle) as the test target nozzle (S012: YES), the controller 60 lands the ink ejected from the test target nozzle and a different nozzle of the plurality of nozzles that is different from the test target nozzle on the film sheet in the overlapping manner.

Described in detail, the controller 60 forms a background image BG by landing the white ink ejected from the white ink nozzle on the film sheet (S014). Thereafter, the controller 60 forms the nozzle test pattern NP(C), NP(M), and NP(K) formed with the ink ejected from the test target nozzle on the film sheet by landing the ink (that is, the ink of a chromatic color) ejected from the test target nozzle on the background image BG (S015). Here, the white ink nozzle corresponds to the above-described different nozzle. In other words, when the color of the ink ejected from the test target nozzle is a chromatic color, ink ejected from the test target nozzle and the different nozzle is landed on the film sheet in the overlapping manner, and the white color is selected as the color of the ink ejected from the different nozzle.

Now, the sequence for forming the background image BG will be described in more detail. When the nozzle test pattern NP(C), NP(M), and NP(Y) is formed by setting the nozzle that ejects ink of a chromatic color as the test target nozzle, the controller 60 coats a predetermined area of the film sheet with the white ink in the monochrome color. As a result, the background image BG that is formed with the white ink is formed in the predetermined area. Here, the predetermined area is an approximately rectangular area that surrounds the nozzle test pattern NP when the nozzle test pattern NP of a nozzle that ejects ink of a chromatic color is formed. In addition, the background image BG is an example of the base and has the form and the size that are the same as those of the predetermined area.

After forming the background image BC, the controller 60 forms the nozzle test pattern NP(C), NP(M), and NP(Y) of the test target nozzle on the background image BG by landing the ink (that is, ink of a chromatic color) ejected from the test target nozzle on the background image BG.

The nozzle test pattern NP(C), NP(M), and NP(Y) of each nozzle from which ink of a chromatic color is ejected, formed as described above, is constituted by the blocks BP(C), BP(M), and BP(Y), the number of which is the same as the number of nozzle holes configuring each nozzle. In other words, the nozzle test pattern NP(C), NP(M), and NP(Y) of each nozzle from which ink of a chromatic color is ejected has a shape that is approximately the same as that of the nozzle test pattern NP(C), NP(M), and NP(Y) formed in the reference example.

In addition, each block BP(C), BP(M), and BP(Y), as shown in FIG. 10, is formed in an island form floating on the background image BG. In other words, in this embodiment, the nozzle test patterns NP(C), NP(M), and NP(Y) of nozzles from which ink of chromatic colors is ejected are formed so as to be surrounded by the background image BG.

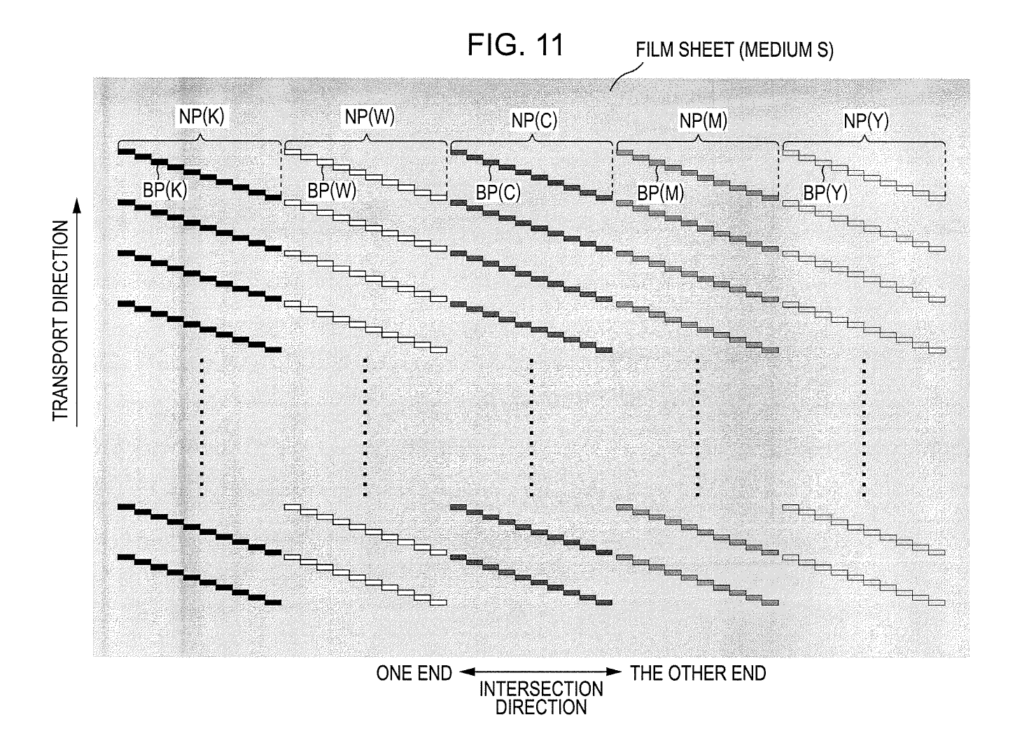

As can be known from comparing FIGS. 10 and 11, the nozzle test patterns NP(C), NP(M), and NP(Y) of each nozzle from which ink of a chromatic color is ejected can be more easily recognized visually by being formed on the white background image BG The reason is that, while the ink of a chromatic color cannot be easily seen through for a case where the ink of the chromatic color directed lands on the film sheet as described above, when the ink of the chromatic color is landed on the background image BCA the ink of the chromatic color cannot be seen through due to light blocking action of the background image BG. FIG. 11 is a diagram for being compared to FIG. 10 and shows a case where the nozzle test patterns NP(C), NP(M), and NP(Y) of each nozzle from which ink of chromatic colors is ejected are directly printed on the film sheet.

In accordance with the above-described sequence, the controller 60 repeats the dot forming operation and the transport operation until there is no more print data received from the printer driver 111 (S016). Then, at the time point when there is no print data, the nozzle test pattern forming process is completed.

In addition, in this embodiment, the background image BG is formed with the white ink. However, the invention is not limited thereto. Thus, as the ink that forms the background image BC ink of a different color may be used as long as it has the light blocking property. However, it is preferable that the background image BG is formed with the white ink in the viewpoint that the nozzle test patterns NP(C), NP(M), and NP(Y) can be distinguished so as to be easily seen for a case where the nozzle test patterns NP(C), NP(M), and NP(Y) from which ink of chromatic colors are ejected are formed on a colorless transparent film sheet.

Moreover, when the background image BG is formed, in order to avoid the influence of a case where nozzle missing occurs in some of white ink nozzle holes, it is preferable that white ink ejected from a plurality of white ink nozzle holes is landed on the film sheet. In addition, it is preferable to test the defective ink-ejection of the white ink nozzles from which white ink is ejected before the background image BG is formed. In other words, it is preferable that the nozzle test pattern NP(W) of the white ink nozzle is formed, and the nozzle test pattern NP(W) is recognized visually before the background image BG is formed.

Furthermore, after the background image BG is formed, in order to form the nozzle test patterns NP(C), NP(M), and NP(K) of nozzles, from which ink of chromatic colors is ejected, on the background image BG, the feed roller 21 and the transport roller 22 may be configured to be rotated in the reverse direction so as to transport the film sheet from the downstream side to the upstream side in the transport direction after the formation of the background image BG. In such a case, it is possible to dispose the nozzle face of the head 22 so as to face a portion of the film sheet in which the background image BG is formed.

### Effectiveness of Printer 10 of this Embodiment

According to the printer 10 of this embodiment, when the nozzle test pattern NP of the test target nozzle is formed on the medium S, the controller 60 lands the ink ejected from the test target nozzle and the different nozzle on the transparent color medium S so as to be overlapped with each other. As a result, even when the color of the ink that is ejected from the test target nozzle is a color that cannot be easily identified from the transparent color, the nozzle test pattern NP can be formed so as to be easily recognized visually by the user.

In other words, as described above, in the printer 10 that prints an image on a transparent color film sheet, usually, the film sheet is set as the medium S, and the film sheet is used as the medium S also in the nozzle test pattern forming process. Particularly when the film sheet has been set in a large-scale printer 10 such as a printer for business, it is inconvenient to replace the film sheet with a different medium (for example, a roll sheet) only for the nozzle test pattern forming process. Accordingly, in the printer 10 in which the film sheet is set as the medium S, there area cases where the nozzle test pattern NP is formed on the film sheet.

When each of the plurality of nozzles included in the head 22 is set as the test target nozzle, and the nozzle test pattern NP of each test target is formed on a transparent color medium S such as a film sheet, as described above, there are cases where the nozzle test pattern NP may not be easily identified in relation to the transparent color depending on the color of ink ejected from the test target nozzle. For example, when ink of a chromatic color lands on the transparent color film sheet, the ink of the chromatic color is seen through, and accordingly the ink cannot be easily identified by the user. Thus, the nozzle test pattern NP formed with ink that is not easily identified in relation to the transparent color cannot be easily recognized visually by the user.

On the other hand, according to this embodiment, when the nozzle test pattern NP is formed on the transparent color medium S with the nozzle, from which ink of a color that cannot be easily identified in relation to the transparent color is ejected, set as the test target nozzle, ink ejected from the test target nozzle and a different nozzle is landed on the above-described transparent color medium S so as to be overlapped with each other. Described in detail, according to this embodiment, a background image BG that is formed with white ink is formed on a transparent color medium S by landing the white ink ejected from the white ink nozzle (the different nozzle) on the transparent color medium S. Thereafter, the nozzle test patterns NP(C), NP(M), and NP(Y) formed with the ink of chromatic colors are formed by landing the ink of the chromatic colors ejected from the test target nozzle on the background image BG

Since the portion of the transparent color medium S in which the background image BG is formed, as described above, does not transmit light, ink landed on the background image BG is not seen through. In addition, the nozzle test patterns NP(C), NP(M), and NP(Y) formed with ink of chromatic colors can be easily recognized visually by a user by forming a base (that is, the background image BG) having the light blocking property between the nozzle test patterns NP(C), NP(M), and NP(Y) and the transparent color medium S. As described above, according to this embodiment, even when the color of ink ejected from the test target nozzle is a color that cannot be easily identified in relation to the transparent color, the nozzle test pattern NP of the test target nozzle can be formed so as to be easily recognized visually by the user.

In addition, according to this embodiment, the nozzle test pattern NP(K) that is formed by setting the black ink nozzle as the test target nozzle is formed by directly landing the black ink not on the background image BG but on the medium S. In other words, the nozzle test pattern NP(K) that is formed with the black ink that is ink of an achromatic color is formed without using the background image BG as the base. However, the invention is not limited thereto. Thus, the nozzle test pattern NP(K), similar to the nozzle test patterns NP(C), NP(M), and NP(Y) formed with ink of chromatic colors, may be also configured to be formed by using the background image BG as the base. In other words, when a nozzle that ejects ink, among ink of five colors that is used in the printer 10, other than ink forming the background image BG is set as the test target nozzle, the nozzle test pattern NP may be configured to be formed by using the background image BG as the base. Since the black ink does not have the light blocking property of the degree that is the same as that of white ink as achromatic ink, the nozzle test pattern NP(K) may be formed on the background image BG so as to be more easily recognized visually.

### Second Embodiment

In the above-described embodiment (hereafter, referred to as a first embodiment), the background image BG formed with ink ejected from a different nozzle that is different from the test target nozzle is formed, and then, ink ejected from the test target nozzle is landed on the background image BG. In other words, according to the first embodiment, the nozzle test pattern NP formed with the ink ejected from the test target nozzle is formed on the background image BG. Accordingly, even when the color of the ink ejected from the test target nozzle is a color that is not easily identified in relation to the transparent color, the nozzle test pattern NP of the test target nozzle can be formed so as to be easily recognized visually by the user.

However, as a method of forming the nozzle test pattern NP of the test target nozzle, from which ink of a color that is not easily identified in relation to the transparent color is ejected, so as to be easily recognized visually by the user is not limited thereto. Thus, another example (hereinafter, referred to as a second embodiment) may be considered. Hereinafter, the second embodiment of the invention will be described. In the following description, similarly to the first embodiment, a case where a transparent color film sheet is used as the medium S will be described as an example.

Also in the second embodiment, same as in the first embodiment, when the nozzle test pattern NP is formed by setting the nozzle from which ink of a color that is not easily identified in relation to the transparent color as the test target nozzle, the ink ejected from the test target nozzle and the different nozzle is landed on the film sheet in the overlapping manner. Here, the ink ejected from the test target nozzle and the ink ejected from a different nozzle has different colors and are mixed together (spread into each other). In other words, according to the second embodiment, the ink ejected from the test target nozzle and the ink ejected from the different nozzle are landed on the film sheet in the overlapping manner so as to be mixed together.

As a result, the nozzle test pattern NP that is formed by setting the nozzle from which ink of a color that is not easily identified in relation to the transparent color as the test target nozzle has a color (that is, a color different from the color of the ink ejected from the test target nozzle) acquired by mixing the ink ejected from the test target nozzle and the ink ejected from the different nozzle.

Accordingly, even when the color of the ink ejected from the test target nozzle is a color that is not easily identified in relation to the transparent color, the nozzle test pattern NP of the test target nozzle can be changed into a color that can be more easily identified, and the nozzle test pattern NP can be formed so as to be easily recognized visually by the user. In addition, the ink to be mixed with the ink ejected from the test target nozzle is ink that improves the contrast for a case where the ink is mixed with the ink ejected from the test target nozzle to be higher than the contrast between the color of the ink ejected from the test target nozzle and the transparent color.

Hereinafter, the sequence for forming the nozzle test pattern NP by setting the nozzle, from which ink of a color that cannot be easily identified in relation to the transparent color, as the test target nozzle, according to the second embodiment will be described. Hereinafter, a case where the nozzle test pattern NP is formed by setting ink (yellow ink) of yellow that cannot be identified the most in relation to the transparent color as the test target nozzle will be described as an example.

According to the second embodiment, when the nozzle test pattern NP of a yellow ink nozzle is formed on a film sheet, the controller 60 lands the ink ejected from the yellow ink nozzle and cyan ink ejected from a cyan ink nozzle on the film sheet in the overlapping manner. In other words, in this case, the cyan ink nozzle corresponds to the different nozzle.

Described in more detail, the controller 60 lands the cyan ink ejected from the cyan ink nozzle in a predetermined unit area of the film sheet, and then, lands the yellow ink ejected from the yellow ink nozzle in the predetermined unit area. Here, the predetermined area is a unit area corresponding to the pixel data constituting the image data of the nozzle test pattern NP of the yellow ink. In addition, the yellow ink and the cyan ink that are landed on the film sheet in the overlapping manner are ejected from a cyan ink nozzle hole and a yellow ink nozzle hole that are located in the same position in the transport direction. For example, in a position in which the cyan ink ejected from cyan ink nozzle hole #k, the yellow ink ejected from the yellow ink nozzle hole #k lands. Additionally, the sequence of landing the ink on the film sheet may be reversed from the description above.

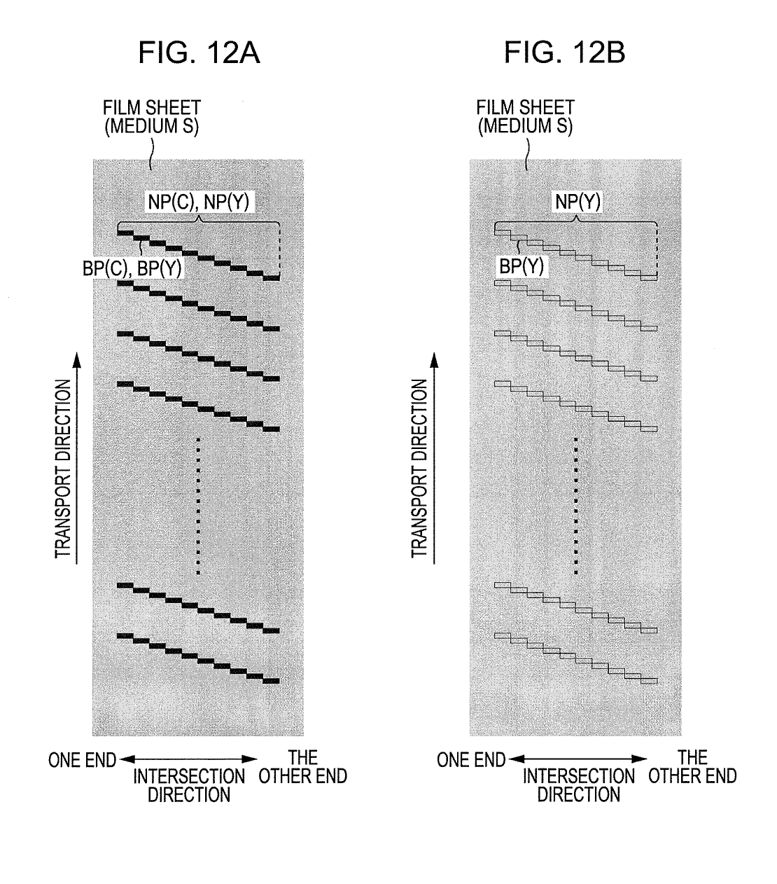

Then, the yellow ink and the cyan ink that are landed on the film sheet in the overlapping manner are mixed together. As a result, as the nozzle test pattern NP of the yellow ink nozzle, a nozzle test pattern (hereinafter, referred to as a mixed nozzle test pattern NP(CY)) having a color (a dark yellow-green color) acquired by mixing the yellow ink and the cyan ink is formed on the film sheet, as shown in FIG. 12A. FIG. 12A is a diagram showing the mixed nozzle test pattern NP(CY). In addition, in order to mix the cyan ink and the yellow ink well, it is preferable that a dot forming operation for landing the cyan ink on the film sheet and a dot forming operation for landing the yellow ink in a position in which the cyan ink lands is the same dot forming operation (that is, the same pass).

The mixed nozzle test pattern NP(CY), as shown in FIG. 12A, is configured by blocks BP (hereinafter, referred to as mixed blocks BP(CY)), the number of which is the same as the number of nozzle holes configuring the yellow ink nozzle. In addition, each of the mixed blocks BP(CY) corresponds to one yellow ink nozzle hole that configures the yellow ink nozzle. The correspondence relationship between the mixed block BP(CY) and the yellow ink nozzle hole is the same as the above-described correspondence relationship.

The mixed nozzle pattern NP(CY) formed as described above has a color that can be more easily identified than the yellow monochrome color in relation to the transparent color (the tone of color). As a result, the mixed nozzle test pattern NP(CY) formed as the nozzle test pattern NP of the yellow ink nozzle, as can be known from comparing FIGS. 12A and 12B, can be more easily recognized visually than the nozzle test pattern NP(Y) that is printed in a monochrome color with yellow ink. FIG. 12B is a diagram for being compared to FIG. 12A. FIG. 12B is a diagram showing the nozzle test pattern NP(Y) that is printed in a monochrome color with the yellow ink by setting the yellow ink nozzle as the test target nozzle.

As described above, according to the second embodiment, when the nozzle test pattern NP is formed by setting a nozzle that ejects ink of a color that cannot be easily identified in relation to the transparent color, the color of the nozzle test pattern NP is changed to a color different from the color of ink ejected from the test target nozzle, in particular, a color than can be more easily identified by the user. Accordingly, the nozzle test pattern NP is formed so as to be easily recognized visually by the user.

In addition, it is preferable that the mixing ratio of the ink (in particular, the yellow ink and the cyan ink) to be mixed can be adjusted. By adjusting this mixing ratio to an appropriate value, the contrast between the color acquired by mixing both ink and the color of the medium S may be increased. In such a case, when the mixed nozzle pattern NP(CY) is formed, it is preferable that the mixing ratio is appropriately adjusted.

Moreover, by visually recognizing the mixed nozzle test pattern NP(CY) formed in the above-described sequence, defective ink-ejection of both the yellow ink nozzle (test target nozzle) and the cyan ink nozzle (different nozzle) can be tested. In other words, while the mixed nozzle test pattern NP(CY) is the nozzle test pattern NP of the yellow ink nozzle, it is also the nozzle test pattern NP of the cyan ink nozzle. Accordingly, when the mixed nozzle pattern NP(CY) is formed, the nozzle test pattern NP of the cyan ink nozzle needs not to be formed, and a user can perform the nozzle test efficiently. However, the invention is not limited thereto. Thus, the nozzle test pattern NP of the cyan ink nozzle may be configured to be formed in addition to the mixed nozzle test pattern NP(CY).

### Other Embodiments

As above, a liquid ejecting apparatus and a method of forming a nozzle test pattern according to embodiments of the invention have been described. However, the above-described embodiments are not for limiting the scope of the invention but for easy understanding of the invention. The invention may be changed or modified without departing from the basic idea thereof, and equivalents of the invention also belong to the scope of the invention.

In particular, the colors of ink ejected from the test target nozzle and ink ejected from the different nozzle are not limited to the above-described embodiments. For example, a nozzle for ejecting ink of light cyan (LC), a nozzle for ejecting ink of light magenta (LM), a nozzle for ejecting ink of light yellow (LY), a nozzle for ejecting ink of light black (LK), and the like may be further disposed on the nozzle face of the head 22, in addition to the nozzles of CMYK colors and the nozzle of white ink.

Among the ink ejected from the above-described nozzles, for example, light magenta ink (LM) is ink of a color that cannot be easily identified in relation to the transparent color. Accordingly, when the nozzle test pattern NP is formed on the transparent color medium S by setting the nozzle that ejects light magenta ink (LM) as the test target nozzle, the ink ejected from the test target nozzle and the ink ejected from the different nozzle are landed on the transparent color medium S so as to be overlapped with each other. In addition, it is preferable that the nozzle that ejects light yellow ink (LY) is used as the different nozzle. In such a case, as the nozzle test pattern NP of the nozzle that eject light magenta ink (LM), the nozzle test pattern NP having a color (a color acquired by mixing light yellow ink and light magenta ink; in particular, light orange) that can be more easily identified than light magenta is formed.

In addition, in the above-described embodiments, the nozzle test pattern NP has been described to be formed additionally to printing a target print material so as to assure the printing quality of the target print material. However, the invention is not limited thereto. For example, formation of the nozzle test pattern NP may be performed independently from printing of the target print material. In other words, when a user clicks on the nozzle testing button 122a at any arbitrary timing in a standby period of the printer 10, a command for forming the nozzle test pattern NP may be configured to be issued to the printer 10 regardless of printing the target print material.

Moreover, in the above-described embodiment, the printer 10 (a so-called serial printer) that has the head 22 moving in the moving direction has been described. However, the invention is not limited thereto. For example, an embodiment of the invention may be applied to a printer (a so-called line printer) that has a head 22 disposed in a fixed position without moving and can form a plurality of dots aligned along the direction intersecting the transport direction of the medium S once.

In addition, in the above-described embodiment, as an example of the liquid ejecting apparatus, the printer 10 that forms an image by ejecting ink has been described. However, an embodiment of the invention may be applied to a liquid ejecting apparatus that ejects liquids (including a liquid body in which particles of function materials are dispersed and a liquid body such as gel other than the liquid) other than ink.

As examples of such liquid injecting apparatuses, there are: a liquid ejecting apparatus that ejects a liquid that contains a material such as an electrode material or a coloring material in a dispersed form or dissolved form that is used for manufacturing a liquid crystal display, an EL (electroluminescence) display, or a field emission display or the like; a liquid ejecting apparatus that ejects bioorganic material that is used for manufacturing a bio chip; and a liquid ejecting apparatus that is used as a precision pipette and ejects a liquid that becomes a test material. In addition, the invention may be applied to: a liquid ejecting apparatus that ejects a lubricant to a precision machine such as a clock or a camera in a pin-point manner; a liquid ejecting apparatus that ejects a transparent resin liquid such as an ultraviolet-curable resin onto a substrate for forming a tiny hemispherical lens (optical lens) used in an optical communication element or the like; a liquid ejecting apparatus that ejects an acid etching solution, alkali etching solution, or the like for etching a substrate or the like; or a liquid-body ejecting apparatus that ejects a gel.

What is claimed is:

1. A liquid ejecting apparatus comprising:
a head that includes a plurality of nozzles disposed for each color of liquids and ejects liquids from the plurality of nozzles onto a medium; and
a control unit that sets one of the plurality of nozzles as a test target nozzle and forms a nozzle test pattern used for testing defective liquid-ejection of the test target nozzle on a transparent color medium by landing the liquids ejected from the test target nozzle and a different nozzle of the plurality of nozzles, which is different from the test target nozzle, on the transparent color medium so as to be overlapped with each other.

2. The liquid ejecting apparatus according to claim 1, wherein the control unit forms the nozzle test pattern, which is surrounded by a base and is formed with the liquid ejected from the test target nozzle, on the transparent color medium by landing the liquid ejected from the different nozzle on the transparent color medium, forming the base that is formed with the liquid ejected from the different nozzle, and then, landing the liquid ejected from the test target nozzle on the base.

3. The liquid ejecting apparatus according to claim 2,
wherein the color of the liquid ejected from the test target nozzle is a chromatic color, and
wherein the color of the liquid ejected from the different nozzle is a white color.

4. The liquid ejecting apparatus according to claim 1, wherein the control unit forms the nozzle test pattern having a color different from the color of the liquid ejected from the test target nozzle on the transparent color medium by landing the liquids ejected from the test target nozzle and the different nozzle on the transparent color medium in the overlapping manner so as to be mixed together.

5. The liquid ejecting apparatus according to claim 4, wherein the color of the liquid ejected from the test target nozzle and the color of the liquid ejected from the different nozzle are different from each other.

6. A method of forming a nozzle test pattern in which one of a plurality of nozzles disposed for each color of liquids is set as a test target nozzle, and the nozzle test pattern for testing defective liquid-ejection of the test target nozzle is formed on a transparent color medium, the method comprising:
landing a liquid ejected from a different nozzle of the plurality of nozzles, which is different from the test target nozzle, on the transparent color medium; and
landing a liquid ejected from the test target nozzle on the transparent color medium so as to be overlapped with the liquid ejected from the different nozzle.
